(19) United States
(12) Patent Application Publication
(10) Pub. No.: US 2012/0302397 A1
(43) Pub. Date: Nov. 29, 2012

(54) METHOD FOR OPTIMISING HYBRID VEHICLE BATTERY RECHARGING

(75) Inventor: Ridouane Habbani, Clichy (FR)

(73) Assignee: PEUGEOT CITROEN AUTOMOBILES SA, Velizy Villacoublay (FR)

(21) Appl. No.: 13/575,272

(22) PCT Filed: Dec. 23, 2010
(86) PCT No.: PCT/FR2010/052899

§ 371 Date: Jul. 25, 2012

(30) Foreign Application Priority Data
Jan. 28, 2010 (FR) 1050585

(51) Int. Cl. B60W 20/00; B60W 10/06; B60W 10/26; B60W 10/02

(52) U.S. Cl. 477/5; 180/65.26; 180/65.28; 903/930

(57) ABSTRACT

The invention essentially relates to a method for optimising the recharging of a hybrid vehicle battery. When the clutch (10) is in the open position and/or when the gearbox (8) is in neutral, the heat engine (7) is at idling speed (W1) by default when the charge status (SOC) of the high-voltage battery (19) is below a parameterisable threshold or a raised idling speed (W2) when the charge status (SOC) of the high-voltage battery (19) is above the parameterisable threshold in order to increase the power generated by the first electrical machine (11) in order to recharge the battery.

### CROSS-REFERENCE TO RELATED APPLICATIONS

This application is a National Stage of International Application No. PCT/FR2010/052899, filed Dec. 23, 2010, which claims priority to French application 1050585, filed on Jan. 28, 2010.

### BACKGROUND

The invention relates to a method for optimizing the recharging of a hybrid vehicle battery.

The invention has a particularly advantageous application in the domain of hybrid vehicles comprising a first axle driven by a combustion engine and a second electrically driven axle.

The specific goal of the invention is to improve the availability of energy for the electrically driven axle, in particular when the vehicle operates in 4×4 mode.

As know, hybrid vehicles comprise a combustion engine providing front wheel traction. For this purpose, a clutch ensures the connection between, on the one hand, the combustion engine and, on the other hand, the transmission connected with the front axle. The idle speed of this combustion engine is approximately 750 rev/min, when the clutch is disengaged and the transmission is in neutral.

The engine is mechanically associated with an alternator/starter type front electrical machine. When driven by the combustion engine, this machine recharges the vehicle batteries (generator mode). This machine also starts the combustion engine when the machine operates in motor mode. In certain operating situations, this machine can also participate in providing traction to the vehicle.

These vehicles also comprise an electrical machine providing traction to the rear axle via a gear box and a coupling device, for instance a dog clutch type device. In contrast to traditional 4×4 vehicles, the front axle traction and the rear axle traction are mechanically independent of each other.

The front electrical machine and the rear electrical machine are connected to a high voltage battery through the intermediary of an electrical network. This high voltage battery is linked to the low voltage on-board network through the intermediary of a DC/DC converter.

A brake control system is in general installed on the wheels of the vehicle. This system prevents blocking of the wheels and in case of need keeps the vehicle on its trajectory.

When the driver selects 4×4 mode by means of a thumbwheel switch, the torque desired by the driver is distributed over the front axle and the rear axle of the vehicle. The torque available on the rear axle directly depends on the charge level of the battery. Indeed, the higher the charge level, the higher the maximum available torque because the discharge power of the battery is high. Inversely, the lower the charge level, the lower the available torque because the discharge power of the battery is low.

### SUMMARY

The specific goal of the invention is to propose a means for efficient recharging of the high voltage battery and for optimizing in this way the available torque in 4×4 mode.

To this end, the idle speed is increased in order to increase the power available to the front machine and therefore the recharge power of the battery when the battery charge is less than an adjustable threshold between 10 and 50% of the maximum charge state.

The idle speed returns to the default idle speed when the charge state of the battery returns above the adjustable threshold.

The invention therefore relates to a method for optimizing the recharging of the battery of a hybrid vehicle comprising:
a combustion engine mechanically associated with a first electrical machine,
a clutch installed between the combustion engine and the transmission connected to one of the axles of the vehicle,
a second electrical machine suitable for providing traction to the other axle of the vehicle,
a high voltage battery connected to both electrical machines,
the first machine is susceptible of being driven by the combustion engine when the first machine operates in generator mode to recharge the high voltage battery,
   characterized in that when the clutch is disengaged and/or the transmission is in neutral:
the combustion engine runs at the default idle speed when the charge state of the high voltage battery is lower than an adjustable threshold, or
a higher idle speed greater than the default idle speed when the charge state of the high voltage battery is greater than the adjustable threshold in order to increase the power generated by the first electrical machine to recharge the high voltage battery.

According to an embodiment, the higher idle speed is about 10 to 40% higher than the default idle speed.

According to an embodiment, the default idle speed is 750 rev/min.

According to an embodiment, the higher idle speed is 950 rev/min.

According to an embodiment, the adjustable threshold is about 10 to 50% of the maximum charge state of the high voltage battery.

### BRIEF DESCRIPTION OF THE DRAWINGS

The invention will be better understood by reading the following description and by examining the accompanying figures. These figures are provided as illustrative but non-limiting examples of the invention. They show:

FIG. 1: a schematic representation of a hybrid vehicle employing the method according to the invention;

FIG. 2: a graphic representation of the power supplied by the front machine (in Watt) as a function of the combustion engine speed (in rev/.min).

Identical elements maintain the same references from one figure to another.

### DETAILED DESCRIPTION

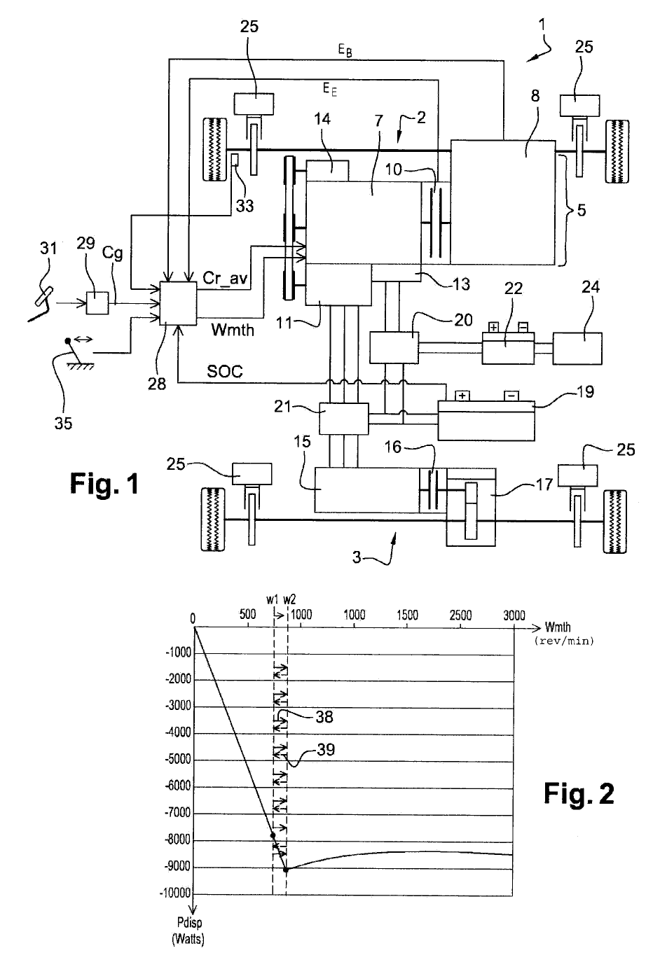

FIG. 1 shows a hybrid vehicle 1 employing the method according to the invention comprising a front axle 2 and a rear axle 3 mechanically independent from each other.

A conventional powertrain group 5 provides traction to the front axle 2 of the vehicle. More precisely, this group 5 comprises a combustion engine 7 connected to an electronic manual transmission 8 (BVMP) through the intermediary of a conventional clutch 10, for instance, a dry or wet clutch. The transmission 8 is connected to the front axle 2 through the intermediary of a gear reduction (not shown). In a variant, the powertrain group 5 could comprise an automatic transmission 8.

The electrical machine 11 is mechanically associated with combustion engine 7. When driven by the engine 7, the electrical machine 11 operates in generator mode and supplies current to the high voltage battery 19 in order to recharge it. Machine 11 can also operate in motor mode to start the combustion engine 7. In certain operating situations, machine 11 provides also traction to the front axle 2 by supplying torque (boost mode).

In the case of very low temperatures and when machine 11 is not capable of providing the start function, a starter 13 is used to start the engine 7. If necessary, a climate control system is mechanically connected with engine 7 and front machine 11.

Furthermore, an electrical machine 15 provides traction to the rear axle 3 of the vehicle. To this end, the machine 15 is connected to the rear axle 3 through the intermediary of a clutch 16 and a gear reduction assembly 17. This clutch 16 consists, for instance, of a dog clutch, while the gear reduction assembly 17 has a single reduction ratio but in a variant could have several ratios.

The two machines 11 and 15 are connected to each other through the intermediary of an electrical network. More precisely, machines 11 and 15 are connected to a high voltage battery 19 through the intermediary of an inverter 21 capable of cutting down the direct voltage of battery 19 to supply the electrical machines 11 and 15 when they operate in motor mode. When these electrical machines 11 and 15 operate in generator mode to recharge battery 19, the inverter 21 is capable of transforming the alternating voltage produced by the machines 11 and 15 into DC voltage applied to the terminals of battery 19.

Battery 19 is connected to a DC/DC converter 20 which transforms the high DC voltage of battery 19 into a voltage suitable for starter 13 and for a low voltage battery 22 connected with the on-board network 24 of the vehicle.

By preference, vehicle 1 is equipped with a conventional ESP or ABS type brake control system 25 which controls the braking forces in case of emergency braking, in order to ensure control of the trajectory of the vehicle and/or to avoid blocking of the wheels.

A processor 28 commands the different control devices of the vehicle to achieve specifically the distribution of the torque Cg requested by the driver between the front axle 2 (torque Ccns_av) and the rear axle 3 (torque Ccns_ar). The requested torque Cg is calculated, by the module 29, called driver intention interpretation module (IVC), specifically as a function of the travel of the accelerator pedal 31 and the speed V of the vehicle measured by a sensor 33 associated with a wheel.

The clutch 1 and the transmission 8 communicate their respective states E_{E} and E_{B} to processor 28. Battery 19 also communicates its charge state to the processor 28. The driver selects the 4×4 operating mode of the vehicle by means of a thumbwheel switch 35. In this operating mode the torque Cg will be divided approximately evenly between the front axle 2 and the rear axle 3 of the vehicle.

As shown in FIG. 2, once the 4×4 mode is activated by the driver by means of the thumbwheel switch 35, and when the processor 28 detects that clutch 10 is disengaged (E_{E}=0) and/or the transmission 8 is in neutral (E_{B}=0) and the charge state SOC is greater than an adjustable threshold, the engine 7 runs at the default idle speed W1 which is in general 750 rev/min. This kind of operating situation can be observed when vehicle 1 is stopped and the combustion engine 7 is running.

According to the invention, when processor 28 detects that clutch 10 is disengaged and/or that the transmission 8 is in neutral, and that the charge state SOC of the battery 19 is lower than the adjustable threshold, the operating point 38 of the combustion engine 7 is shifted, so that the engine runs at higher idle speed W2, greater than the default idle speed W1. In this way, the invention provides an increased speed of machine 11 when it is operating in generator mode to recharge battery 19, and therefore improves the availability of energy in the electrically driven axle 2.

By preference, the higher idle speed W2 is 10 to 40% higher than the default idle speed W1.

Here, the speed W1 is, for instance, approximately 950 rev/min, so that the power Pdisp available to recharge the battery 19 increases from 8 KW (for W1) to 9 KW (for W2), which corresponds with a 12% increase in available power Pdisp.

As soon as the charge state SOC of battery 19 returns above the adjustable threshold, the operating point 39 of the combustion engine 7 is shifted back so that the idle speed of engine 7 returns from the higher speed W2 to the default speed W1.

In an example, the adjustable threshold is 10 to 50% of the maximum charge state of the high voltage battery 19.

The invention can also be employed when the vehicle is not operating in 4×4 mode in order to optimize the recharge of battery 19. In this way, the invention can be employed when the vehicle 1 operates in thermal mode, in other words when only the combustion engine 7 provides traction to the vehicle.

1. A method for optimizing the recharging of a battery of a hybrid vehicle; the hybrid vehicle comprising:
a combustion engine mechanically associated with a first electrical machine,
a clutch installed between the combustion engine and a transmission; the transmission being connected with a first axle of the vehicle,
a second electrical machine electrically suitable for providing traction to a second axle of the vehicle,
a high voltage battery connected with the first and second electrical machines,
the first machine being susceptible of being driven by the combustion engine when the first machine operates in generator mode to recharge the high voltage battery,
wherein that when the clutch is disengaged and/or the transmission is in neutral, the method comprises:
running the combustion engine at a default idle speed (W1) when the charge state (SOC) of the high voltage battery is lower than an adjustable threshold, or
running the combustion engine at a higher idle speed (W2) greater than the default idle speed (W1) when the charge state (SOC) of the high voltage battery is greater than the adjustable threshold in order to increase the power generated by the first electrical machine for recharging of the high voltage battery.

2. The method according to claim 1, wherein the higher idle speed (W2) is 10 to 40% higher than the default idle speed (W1).

3. The method according to claim 1, wherein the default idle speed (W1) is 750 rev/min.

4. The method according to claim 1 wherein the higher idle speed (W2) is 950 rev/min.

5. The method according to claim 1 wherein the adjustable threshold is about 10 to 50% of a maximum charge state (SOC) of the high voltage battery.
